(19) United States
(12) Patent Application Publication
(10) Pub. No.: US 2007/0153470 A1
(43) Pub. Date: Jul. 5, 2007

(54) COMPUTER BEZEL HAVING PIVOTABLE DRIVE COVER

(75) Inventors: YUN-LUNG CHEN, TU CHENG (TW); Da-Long Sun, Shenzhen (CN); Jian-Guo Zeng, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,819

(22) Filed: May 11, 2006

(30) Foreign Application Priority Data
Dec. 30, 2005 (CN) 200520121447.0

(51) Int. Cl. G06F 1/16

(52) U.S. Cl. 361/685; 361/679

(57) ABSTRACT

A computer bezel comprises a base, a pair of sliding members slidingly mounted on the base, a pair of elastic members, and a drive cover pivotably mounted to the sliding members. The base defines an opening for providing access to a data storage device with a moveable tray. The elastic members securely connect the sliding members with the base for rebounding of the sliding members. The drive cover is received in the opening and covers the opening of the base. When the drive cover is pushed outward by the tray of the data storage device from a closed position to an open position, the sliding members and the drive cover are moved together and the drive cover is then rotated about the sliding members.

### FIELD OF THE INVENTION

The present invention relates to computer bezels, and more particularly to a computer bezel having a pivotable drive cover.

### DESCRIPTION OF RELATED ART

A data storage device is a vital component in a computer system for storing and accessing data. The data storage device may be a CD-ROM drive, a DVD-ROM drive, and so on. Conventionally, one kind of computer enclosure has a computer bezel with an opening defined therein. The bezel is mounted on a front panel of the computer enclosure, and the storage device is attached to the enclosure through the opening of the bezel. However, the exposed data storage device gives access to dust in the air, which may damage the data storage device and cut down its service life.

A typical enclosure has a dustproof door attached to the bezel and covering the opening of the bezel. However, the door must be manually opened and closed when gaining access to a data storage device therein. This is inconvenient and troublesome. Thus, it is strongly desired to provide a computer bezel having a pivotable drive cover which solves the above-mentioned problems.

What is needed, therefore, is a computer bezel having a pivotable drive cover.

### SUMMARY OF INVENTION

A computer bezel comprises a base, a pair of sliding members slidingly mounted on the base, a pair of elastic members, and a drive cover pivotably mounted to the sliding members. The base defines an opening for providing access to a data storage device with a moveable tray. The elastic members securely connect the sliding members with the base for rebounding of the sliding members. The drive cover is received in the opening and covers the opening. When the drive cover is pushed outward by the tray of the data storage device from a closed position to an open position, the sliding members and the drive cover are moved together and the drive cover is then rotated about the sliding members.

Other advantages and novel features will be drawn from the following detailed description of preferred embodiments with the attached drawings, in which:

### BRIEF DESCRIPTION OF THE DRAWINGS

FIG. 1 is an exploded, isometric view of a computer bezel in accordance with a preferred embodiment of the invention, together with a drive cover, a pair of sliding members, a pair of first elastic members, and a pair of second elastic members;

FIG. 2 is an enlarged view of the sliding member of FIG. 1;

FIG. 3 is an enlarged view of the drive cover of FIG. 1;

FIG. 4 is an assembled view of the computer bezel of FIG. 1, showing the drive cover thererof in an open position;

FIG. 5 is another assembled view of the computer bezel of FIG. 1, but viewed from another aspect, showing the drive cover and a tray in an open position; and

FIG. 6 is similar to FIG. 5, but showing the drive cover and the tray in a closed position.

### DETAILED DESCRIPTION

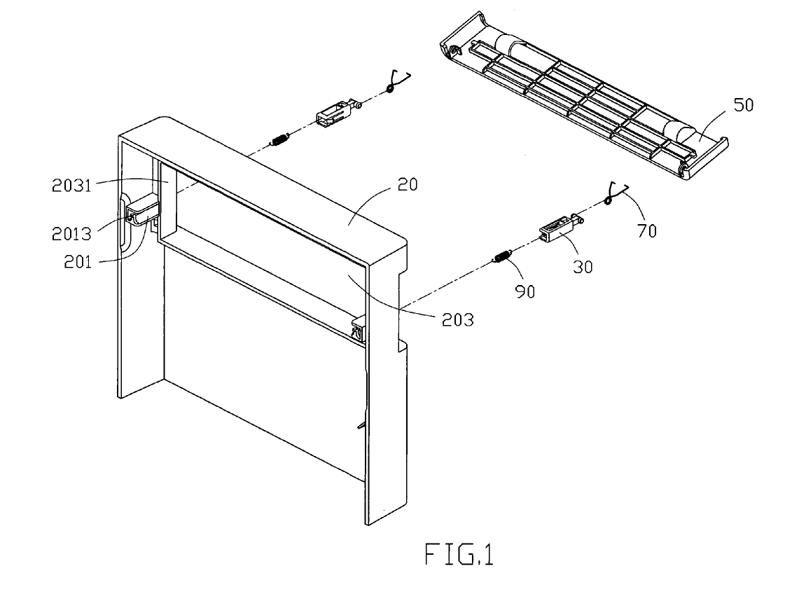

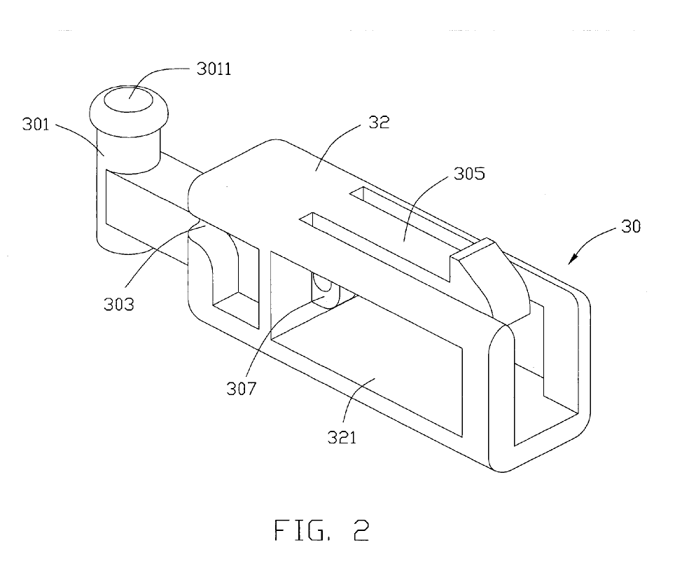

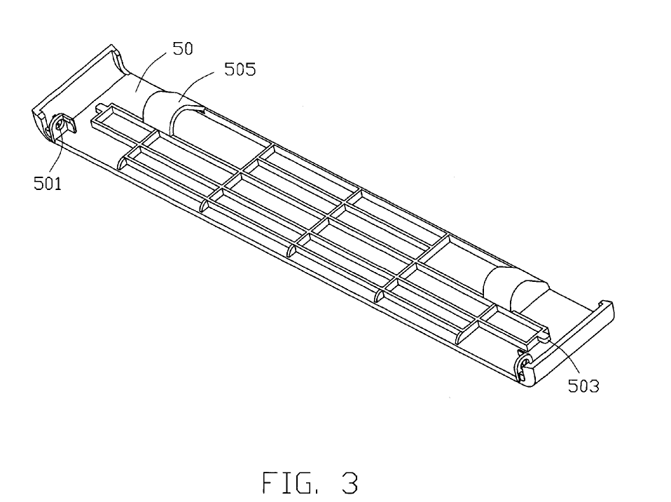

Referring to FIGS. 1, 2 and 3, a computer bezel of a computer enclosure in accordance with a preferred embodiment of the invention comprises a base 20, a pair of sliding members 30, a drive cover 50, a pair of first elastic members 70, and a pair of second elastic members 90. In the preferred embodiment of the invention, the first elastic member 70 may be a torsion spring, and the second elastic member 90 may be an extension spring.

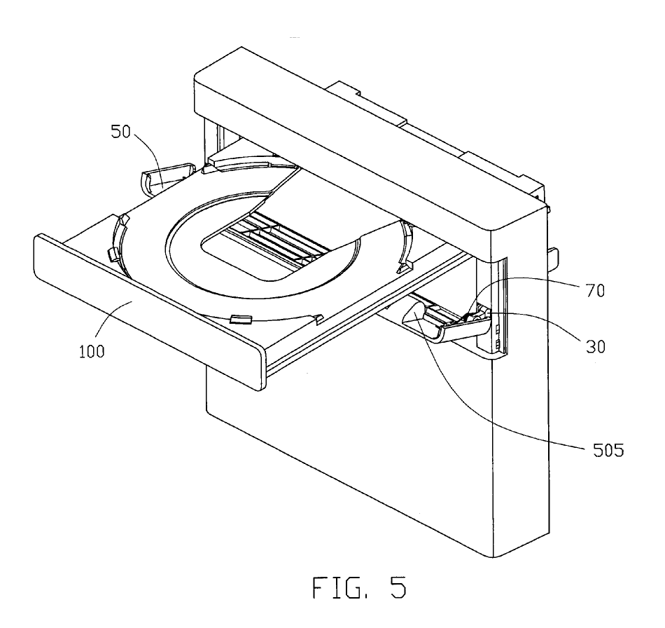

An inner side of the base 20 defines a pair of receiving slots 201 for slidingly receiving the sliding members 30 therein. A distal end of each receiving slot 201 forms an L-shaped hook 2013 thereon. An upper portion of the base 20 defines a substantially rectangular opening 203 therein between the two receiving slots 201, for providing access to a data storage device with a moveable tray 100 (shown in FIG. 5). The data storage device may be a CD-ROM drive, a DVD-ROM drive, and so on. The opening 203 has two opposite side walls 2031 therein.

Each of the sliding members 30 is slidingly received in the corresponding receiving slot 201 of the base 20. Each sliding member 30 includes a body 32 and a pivot pin 301 connected with the body 32. One end of the pivot pin 301 has a wide head portion 3011 thereon. A latching slot 303 is defined in one end of the body 32 for receiving one end of the first elastic member 70. A receiving groove 321 is defined in the other end of the body 32 for receiving the second elastic member 90. One side of the receiving groove 321 is formed to have an L-shaped elastic latching catch 305 with a slanted surface by stamping thereon. A protrusion 307 with a through hole (not labeled), adjacent to the latching slot 303, extends from the receiving groove 321 horizontally for connecting the other end of the second elastic member 90.

A back side of the drive cover 50 defines a pair of pivot holes 501 therein for extension of the pivot pin 301 of the two sliding members 30 therethrough. The back side of the drive cover 50 is formed to have two opposite stopping bars 503 for positioning the other ends of the first elastic members 70 respectively. A pair of arcuate blocks 505 is formed on the back side of the drive cover 50 for the tray 100 pushing against the blocks 505, thereby urging the drive cover 50 to open.

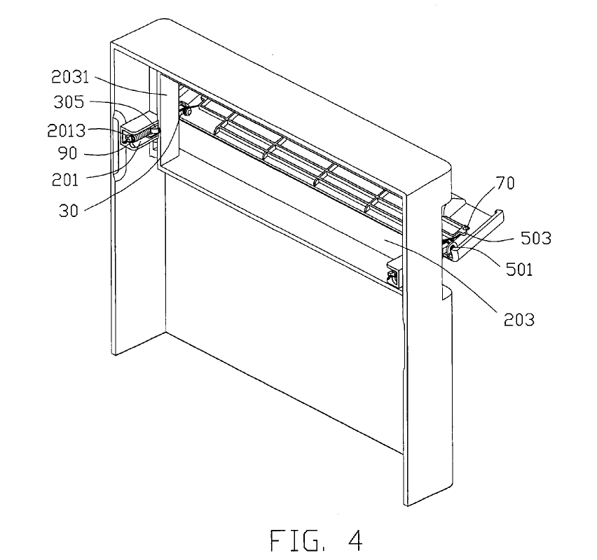

Referring also to FIGS. 1 and 4, in assembly of the computer bezel, the pivot pin 301 of each sliding member 30 is first aligned with and then inserted through the corresponding pivot hole 501 of the drive cover 50. Then, the first elastic members 70 are placed around the pivot pins 301 of the sliding members 30 respectively. The wide head portions 3011 of the pivot pin 301 prevent the first elastic members 70 falling off the pivot pins 301. Simultaneously, one end of each first elastic member 70 engages in the corresponding latching slot 303 of each sliding member 30 respectively, and the other end of each first elastic member 70 engages with the corresponding stopping bar 503 of the drive cover 50 respectively and is positioned by the corresponding stopping bar 503. The drive cover 50 is thus pivotally mounted on the sliding members 30. Subsequently, each second elastic member 90 is received in the receiving groove 321 of each sliding member 30 respectively, and one end of each second elastic member 90 engages in the corresponding through holes of the protrusions 307. Then, the sliding members 30 are pushed inward along the receiving slots 201 of the base 20, and the side walls 2031 of the opening 203 resist against the slanted surfaces of the latching catches 305 of the sliding members 30 respectively, for urging the latching catches 305 to deform inward. The sliding members 30 are thus allowed to further slide in the receiving slots 201. When the latching catches 305 of the sliding members 30 slide over the side walls 2031 of the opening 203, the sliding members 30 are slidingly received in the receiving slots 201 of the base 20 respectively due to rebounding of the latching catches 305. Finally, the other end of each second elastic member 90 is connected with the hook 2013 of each receiving slot 201 respectively.

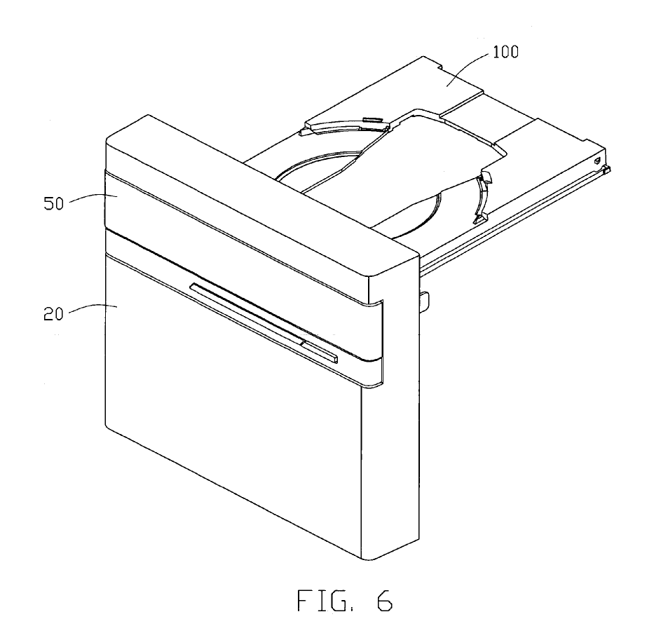

Referring to FIGS. 5 and 6, when the tray 100 is driven, the tray 100 moves outward to push the blocks 505 of the drive cover 50. The second elastic members 90 are first stretched since the elasticity of the second elastic member 90 is less than the elasticity of the first elastic member 70. Consequently, the sliding members 30 are extended out horizontally together with the drive cover 50 until each latching catch 305 is stopped by an edge of the side wall 2031 respectively. A gap (not labeled) is thus generated between the drive cover 50 and the opening 203 of the base 20, for the drive cover 50 freely rotating about the pivot pins 301 of the sliding members 30. Then, the drive cover 50 starts to freely pivot about the pivot pins 301 of the sliding members 30 to an open position until the tray 100 move out of the data storage device entirely. At that moment, the first elastic members 70 are twisted resiliently, and each block 505 of the drive cover 50 abuts against the tray 100.

When the tray 100 is drawn back to the data storage device, the drive cover 50 is first pivoted upward to a closed position due to rebounding of the first elastic members 70. Then, the sliding members 30 slide to an original position along the receiving slots 201 of the base 20 together with the drive cover 50 due to rebounding of the second elastic members 90. Thus, the drive cover 50 covers the opening 203 of the base 20 fully for preventing dust from entering into the data storage device, thereby prolonging service life of the data storage device.

While the present invention has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and illustrative examples shown and described.

What is claimed is:

1. A computer bezel comprising:
a base defining an opening for providing access to a data storage device with a moveable tray;
a pair of sliding members slidingly mounted on the base;
a pair of elastic members securely connecting the sliding members with the base for rebounding of the sliding members; and
a drive cover pivotably mounted to the sliding members and received in the opening of the base; wherein when the drive cover is pushed by the tray of the data storage device from a closed position to an open position, the sliding members are extended out together with the drive cover and the drive cover is then rotated about the sliding members.

2. The computer bezel assembly as described in claim 1, further comprising another pair of elastic members connected between the drive cover and the sliding members for rebounding of the drive cover from the open position to the closed position.

3. The computer bezel assembly as described in claim 1, wherein each of the sliding members defines a receiving groove therein, for receiving the elastic members respectively.

4. The computer bezel assembly as described in claim 1, wherein the base defines a pair of receiving slots for the sliding members sliding therein respectively.

5. The computer bezel assembly as described in claim 4, wherein a hook is formed in the receiving slot for connecting one end of the elastic member, and the sliding member forms a protrusion thereon for connecting the other end of the elastic member.

6. The computer bezel assembly as described in claim 4, wherein the sliding member forms a latching catch thereon, for restricting movement of each of the sliding member in the corresponding receiving slot of the base.

7. The computer bezel assembly as described in claim 1, wherein each of the sliding members has a pivot pin thereon, and the drive cover defines a pair of pivot holes for extension of the pivot pins therethrough, thereby rotatably mounting the drive cover to the sliding members.

8. The computer bezel assembly as described in claim 1, wherein the elastic member is an extension spring.

9. The computer bezel assembly as described in claim 2, wherein the another elastic member is a torsion spring.

10. An assembly comprising:
a data storage device having a tray;
a base defining an opening for the tray of the data storage device extending therethrough, and a pair of receiving slots at opposite side walls of the opening;
a pair of sliding members slidingly received in the corresponding receiving slots; and
a drive cover covering the opening of the base and pivotally attached to the sliding members; wherein the sliding members together with the drive cover are extended out and the drive cover is subsequently rotated about the sliding members when the drive cover is driven by the tray of the data storage device from a closed position to an open position.

11. The computer bezel as described in claim 10, further comprising a pair of first elastic members attached to the drive cover and the sliding members for rebounding of the drive cover from the open position to the closed position.

12. The computer bezel as described in claim 11, further comprising a pair of second elastic members respectively connecting the sliding members with the receiving slots of the base for rebounding of the sliding members.

13. The computer bezel as described in claim 12, wherein each of the sliding members defines a receiving groove therein, for receiving the second elastic members therein respectively.

14. The computer bezel as described in claim 13, wherein a hook is formed in the receiving slot for connecting one end of the second elastic members respectively, and the receiving grooves of the sliding members form a protrusion thereon for connecting the other end of the second elastic members respectively.

15. The computer bezel as described in claim 10, wherein each of the sliding members has a pivot pin thereon, and the drive cover defines a pair of pivot holes for extension of the pivot pins therethrough, thereby rotatably mounting the drive cover to the sliding members.

16. The computer bezel as described in claim 10, wherein the sliding members form a latching catch thereon respectively, for restricting movement of each of the sliding members in the corresponding receiving slot of the base.

17. The computer bezel as described in claim 11, wherein the first elastic member is a torsion spring.

18. The computer bezel as described in claim 12, wherein the second elastic member is an extension spring.
